(19) United States
(12) Patent Application Publication
(10) Pub. No.: US 2004/0201814 A1
(43) Pub. Date: Oct. 14, 2004

(54) Liquid crystal display apparatus

(76) Inventor: Takeshi Yamamoto, Fukaya-shi (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/749,396

(22) Filed: Jan. 2, 2004

(30) Foreign Application Priority Data
Jan. 10, 2003 (JP) 2003-004180

(51) Int. Cl. G02F 1/1335

(52) U.S. Cl. 349/156; 349/106

(57) ABSTRACT

A display region that displays an image includes a plurality of pixels which are disposed in a matrix. The pixels include a first pixel with a first gap for interposition of a liquid crystal layer between an array substrate and a counter substrate, and a second pixel with a second gap that is smaller than the first gap. A columnar spacer for creating a gap between the array substrate and counter substrate is disposed not at the first pixel but at the second pixel, and creates the second gap.

### CROSS-REFERENCE TO RELATED APPLICATIONS

This application is based upon and claims the benefit of priority from prior Japanese Patent Application No. 2003-004180, filed Jan. 10, 2003, the entire contents of which are incorporated herein by reference.

### BACKGROUND OF THE INVENTION

1. Field of the Invention

The present invention relates to a liquid crystal display apparatus. More particularly, the invention relates to a liquid crystal display apparatus having a multi-gap structure wherein a gap, with which a liquid crystal layer is interposed, varies from pixel to pixel.

2. Description of the Related Art

In present-day commonly used liquid crystal display apparatuses, a liquid crystal layer is interposed between two glass substrates having electrodes. A gap, with which the liquid crystal layer is interposed, is kept by a spacer such as a plastic bead.

In a liquid crystal display apparatus for color display, color filter layers, which are colored in red, green (G) and blue (B), respectively, are provided on one of the substrates in association with respective pixels. Specifically, a red pixel has a red color filter layer. A green pixel has a green color filter layer. A blue pixel has a blue color filter layer.

The viewing angle characteristics of the liquid crystal display apparatus depend greatly on the gap between the substrates that sandwich the liquid crystal layer. Where an inter-substrate gap is d, a-refractive index anisotropy of a liquid crystal composition of the liquid crystal layer is Δn, the wavelength of light passing through the liquid crystal layer is λ, and u=2·d·Δn/λ, a light transmittance T is generally given by

T=sin²[((1+u²)^{1/2}·π/2)/(1+u²)].

In other words, the effective thickness (d·Δn) of the liquid crystal layer, which maximizes the transmittance T of light passing through the liquid crystal layer, varies depending on the wavelength of the transmission light.

Under the circumstances, there has been proposed a liquid crystal display apparatus having a multi-gap structure, wherein the gap between the substrates that sandwich the liquid crystal layer varies from color pixel to color pixel. In the multi-gap structure, the thicknesses of color filter layers are different between the associated colors. Jpn. Pat. Appln. KOKAI Publication No. 6-347802, for instance, discloses a technique wherein a plurality of kinds of spherical or columnar plastic spacers are dispersed on one of the substrates.

In the liquid crystal display apparatus with the conventional multi-gap structure, however, it is necessary to prepare a plurality of kinds of spacers having different diameters in accordance with the varied gap, or to prepare a plurality of kinds of spacers with different densities. Furthermore, in the manufacturing process, it is difficult to provide a plurality of kinds of spacers-corresponding to the varied gap at the same time in the same step, which leads to an increase in number of fabrication steps. The provision of a plurality of kinds of spacers and the increase in number of fabrication steps will raise the manufacturing cost and lower the manufacturing yield.

Even if the number of fabrication steps is reduced by dispersing spacers in the liquid crystal composition and thus simultaneously providing the spacers and injecting liquid crystal, it is not possible to strictly control the density of spacers that are to be dispersedly applied for each pixel. Consequently, spacers may locally coagulate (e.g. stacking of spherical spacers in the thickness direction of the liquid crystal layer), and a desired gap could not be obtained, resulting in defective display. Moreover, a defect in alignment of the liquid crystal may occur in the vicinity of spherical or columnar spacers, leading to a defect in display.

### BRIEF SUMMARY OF THE INVENTION

The present invention has been made in consideration of the above-described problems, and its object is to provide a liquid crystal display apparatus, which can achieve a high manufacturing yield at low cost, and can realize a high display quality.

According to an aspect of the present invention, there is provided a liquid crystal display apparatus configured to have a liquid crystal layer interposed between a first substrate and a second substrate, comprising: a plurality of pixels which are disposed in a matrix in a display region that displays an image, the pixels including a first pixel with a first gap for interposition of the liquid crystal layer between the first substrate and the second substrate, and a second pixel with a second gap that is smaller than the first gap; and a columnar spacer for creating the second gap, the columnar spacer being disposed not at the first pixel but at the second pixel.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

FIG. 1 schematically shows the structure of a liquid crystal display panel that is applied to a liquid crystal display apparatus of the present invention;

FIG. 2 is a circuit block diagram schematically showing the composition of the liquid crystal display panel shown in FIG. 1;

FIG. 3 is a cross-sectional view schematically showing the structure of a liquid crystal display apparatus according to an embodiment of the present invention;

FIG. 4 is a cross-sectional view schematically showing the structure of an array substrate that forms the liquid crystal display apparatus shown in FIG. 3;

FIG. 5 is a view for explaining a process margin in a developing step, in relation to the film thickness of black resin;

FIG. 6A shows the shape of a columnar spacer that is formed in the embodiment;

FIG. 6B shows the shape of a columnar spacer that is formed in a comparative example;

FIG. 6C shows the shape of a columnar spacer that is formed in a comparative example;

FIG. 7 is a cross-sectional view schematically showing the structure of a liquid crystal display apparatus according to another embodiment of the present invention;

FIG. 8 is a cross-sectional view schematically showing the structure of a liquid crystal display apparatus according to another embodiment of the present invention; and

FIG. 9 is a cross-sectional view schematically showing the structure of a liquid crystal display apparatus according to another embodiment of the present invention.

The accompanying drawings, which are incorporated in and constitute a part of the specification, illustrate embodiments of the invention, and together with the general description given above and the detailed description of the embodiments given below, serve to explain the principles of the invention.

### DETAILED DESCRIPTION OF THE INVENTION

A liquid crystal display apparatus according to an embodiment of the present invention will now be described with reference to the accompanying drawings.

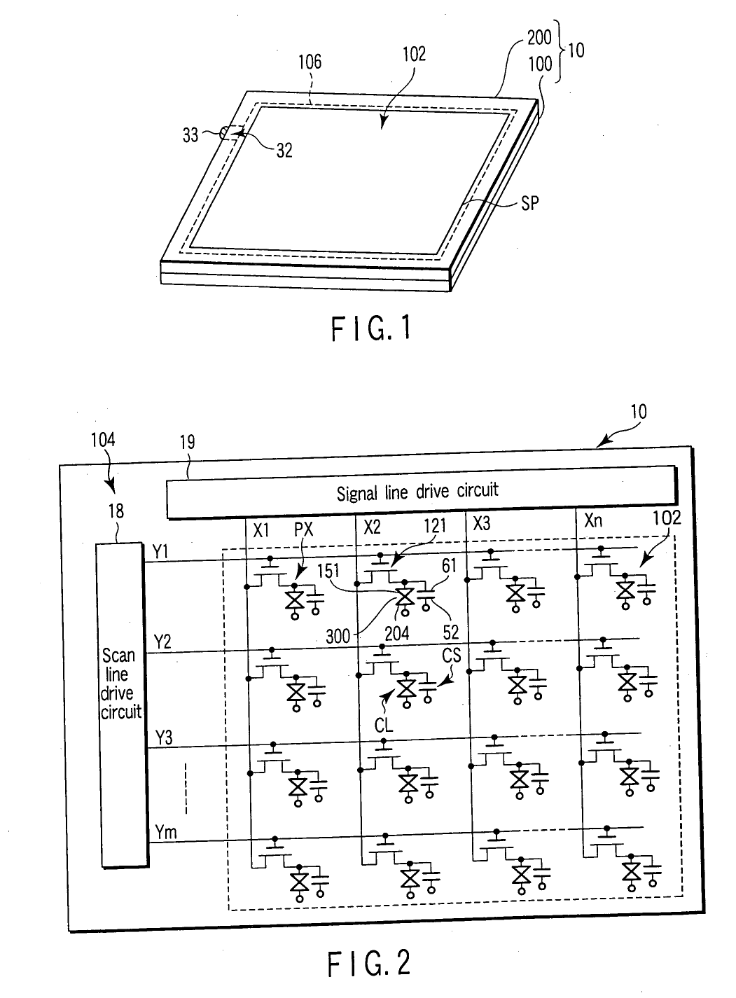

As is shown in FIG. 1 and FIG. 2, a liquid crystal display apparatus according to the embodiment, for example, an active-matrix liquid crystal display apparatus, includes a liquid crystal display panel 10. The liquid crystal display panel 10 comprises an array substrate 100, a counter substrate 200 that is disposed to face the array substrate 100, and a liquid crystal layer 300 that is interposed between the array substrate 100 and counter substrate 200. The array substrate 100 and counter substrate 200 are attached to each other by a seal material 106, with a predetermined gap for interposition of the liquid crystal layer 300 being created therebetween. The liquid crystal layer 300 is formed of a liquid crystal composition that is sealed in the gap defined between the array substrate 100 and counter substrate 200.

In the liquid crystal display panel 10, a display region 102 for displaying an image comprises a plurality of pixels PX that are arranged in a matrix. A peripheral edge portion of the display region 102 is light-shielded by a shield layer SP that is formed in a picture-frame shape.

In the display region 102, the array substrate 100, as shown in FIG. 2, includes an m×n number of pixel electrodes 151, an m-number of scan lines Y1 to Ym, an n-number of signal-lines X1 to Xn, and an m×n number of switching elements 121. On the other hand, in the display region 102, the counter substrate 200 includes a counter electrode 204.

The pixel electrodes 151 are disposed in a matrix in the display region 102. The scan lines Y are disposed in the row direction of the pixel electrodes 151. The signal lines X are disposed in the column direction of the pixel electrodes 151. The switching elements 121 are formed of thin-film transistors with polysilicon semiconductor layers, i.e. pixel TFTs. The switching elements 121 are disposed near intersections of the scan lines Y and signal lines X in the respective pixels PX. The counter electrode 204 is commonly provided for all the pixels PX. The counter electrode 204 is opposed to all the m×n pixel electrodes 151 via the liquid crystal layer 300.

The array substrate 100 includes, in a peripheral region 104 around the display region 102, a scan line drive circuit 18 including drive TFTs for driving the scan lines Y1 to Ym, and a signal line drive circuit 19 including drive TFTs for driving the signal lines X1 to Xn. The drive TFTs included in the scan line drive circuit 18 and signal line drive circuit 19 are composed of n-channel thin-film transistors and p-channel thin-film transistors with polysilicon semiconductor layers.

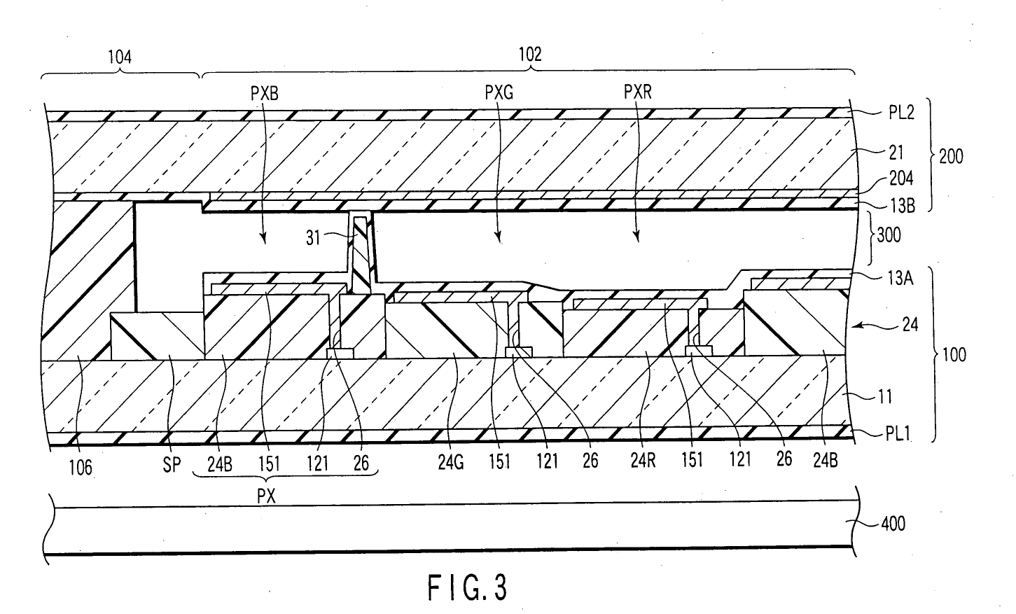

The liquid crystal display panel 10 shown in FIGS. 1 and 2 is of a transmission type wherein light is selectively passed, for example, from the array substrate 100 side to the counter substrate 200 side. Thus, the liquid crystal display apparatus includes, as shown in FIG. 3, a transmission-type liquid crystal display panel 10 and a backlight unit 400 that illuminates the liquid crystal display panel 10 from the back side (i.e. outer-surface side of array substrate 100).

In the display region 102 of the liquid crystal display apparatus shown in FIG. 3, the array substrate 100 includes, on a transparent insulative substrate 11 such as a glass substrate, pixel TFTs 121 arranged for the respective pixels PX, color filters 24 (R, G, B) formed to cover the pixel TFTs 121, pixel electrodes 151 disposed on the color filter layers 24 for the respective pixels PX, a columnar spacer 31 formed on the color filter layer 24, and an alignment film 13A formed to cover the entire pixel electrodes 151. In the peripheral region 104, the array substrate 100 includes the shield layer SP so as to surround the outer periphery of the display region 102.

A red pixel PXR includes a red color filter layer 24R. A green pixel PXG includes a green color filter layer 24G. A blue pixel PXB includes a blue color filter layer 24B.

The color filter layers 24 (R, G, B) are composed of color resin layers that are colored in red (R), green (G) and blue (B). The color filter layers 24 (R, G, B) mainly pass red light, green light and blue light, respectively.

The pixel electrode 151 is formed of a light-transmissive electrically conductive material such as ITO (Indium Tin Oxide). Each pixel electrode 151 is connected to the associated pixel TFT 121 via a through-hole 26 that penetrates the associated color filter layer 24 (R, G, B).

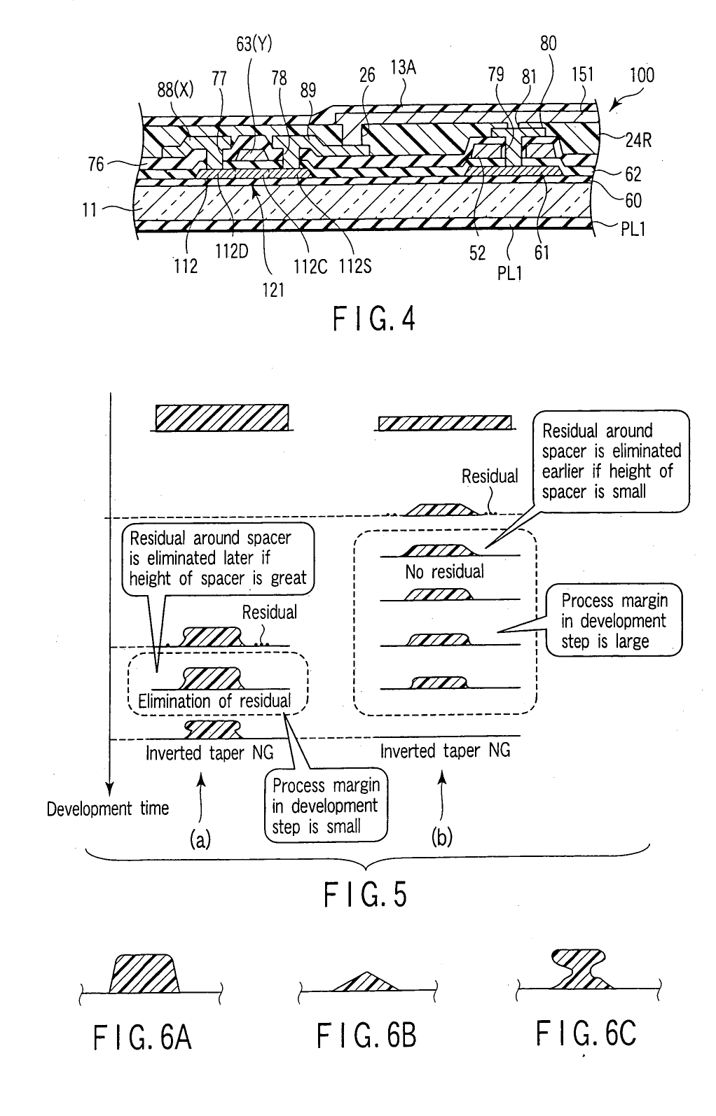

FIG. 4 shows the structure of each pixel TFT 121 in greater detail. The pixel TFT 121 includes a semiconductor layer 112 that is formed of polysilicon. The semiconductor layer 112 is disposed on an undercoating layer 60 formed on the insulative substrate 11. The semiconductor layer 112 includes a drain region 112D and a source region 112S, which are formed by doping areas on both sides of a channel region 112C with impurities.

A gate electrode 63 of the pixel TFT 121 is formed integral with the scan line Y. The gate electrode 63 is disposed to be opposed to the semiconductor layer 112 via a gate insulation film 62. A drain electrode 88 is formed integral with the signal line X. The drain electrode 88 is electrically connected to the drain region 112D of the semiconductor layer 112 via a contact hole 77 that penetrates the gate insulation film 62 and an interlayer insulation film 76. The source electrode 89 is electrically connected to the source region 112S of the semiconductor layer 112 via a contact hole 78 that penetrates the gate insulation film 62 and interlayer insulation film 76. In addition, the source electrode 89 is electrically connected to the pixel electrode 151 via a through-hole 26 formed in the color filter layer 24 (R, G, B). Thereby, the pixel TFT 121 is connected to the scan line Y and signal line X. The pixel TFT 121 is turned on by a drive voltage that is applied from the scan line Y and applies a signal voltage from the signal line X to the pixel electrode 151.

The pixel electrode 151 is electrically connected to an auxiliary capacitance element 61 that forms an auxiliary capacitance CS, which is electrically in parallel with a liquid crystal capacitance CL. The auxiliary capacitance electrode 61 is formed of a polysilicon film that is doped with impurities. The auxiliary capacitance electrode 61, like the semiconductor layer 112, is disposed on the undercoating layer 60. A contact electrode 80 is electrically connected to the auxiliary capacitance electrode 61 via a contact hole 79 that penetrates the gate insulation film 62 and interlayer insulation film 76. The pixel electrode 151 is electrically connected to the contact electrode 80 via a contact hole 81 that penetrates the color filter layer 24. Thereby, the potentials of the source electrode 89 of pixel TFT 121, the pixel electrode 30 and the auxiliary capacitance electrode 61 are equalized. On the other hand, an auxiliary capacitance line 52 has at least a part that is disposed to be opposed to the auxiliary capacitance electrode 61 via the gate insulation film 62, and the auxiliary capacitance line 52 is set at a predetermined potential.

The wiring including the signal lines X, scan lines Y and auxiliary capacitance lines 52 is formed of light-shielding low-resistance material such as aluminum or molybdenum-tungsten. In this embodiment, the scan lines Y and auxiliary capacitance lines 52, which are disposed substantially in parallel, are formed of molybdenum-tungsten. The signal lines X, which are disposed substantially perpendicular to the scan lines Y via the interlayer insulation film 76, are mainly formed of aluminum. The drain electrode 88 which are integral with the signal line X, source electrode 89 and contact electrode 80, are mainly formed of aluminum, like the signal line.

On the other hand, as shown in FIG. 3, the shield layer SP is formed of a photosensitive resin material with light-shield properties for preventing passage of light, for example, a color resin such as a black resin. The columnar spacer 31 is formed of a color resin such as a black resin. The columnar spacer 31 is disposed on the blue color filter layer 24B so as to be located on the wiring with light-shield properties.

The alignment film 13A functions to align liquid crystal molecules included in the liquid crystal layer 300 in a predetermined direction.

The counter substrate 200 includes the counter electrode 204 that is formed on a transparent insulative substrate 21 such as a glass substrate, and an alignment film 13B that covers the counter electrode 204. The counter electrode 204 is formed of a light-transmissive electrically conductive material such as ITO. The alignment film 13B functions to align liquid crystal molecules included in the liquid crystal layer 300 in a predetermined direction. A polarizing plate PL1 is provided on an outer surface of the array substrate 100. A polarizing plate PL2 is provided on an outer surface of the counter substrate 200.

In the above-described liquid crystal display apparatus, light emitted from the backlight unit 400 illuminates the liquid crystal display panel 10 from the outer surface side of the array substrate 100. The light that has passed through the polarizing plate PL1 and entered the liquid crystal display panel 10 is modulated while it is passing through the liquid crystal layer 300. The modulated light selectively passes through the polarizing plate PL2 of the counter substrate 200. Thus, an image is displayed on the display region 102 of liquid crystal display panel 10.

The above-described liquid crystal display panel 10 has a multi-gap structure wherein the gap between the substrates that sandwich the liquid crystal layer 300 varies from color pixel to color pixel. In other words, the gap between the substrates at each pixel PX (i.e. the gap corresponding to a thickness d of the liquid crystal layer 300 that is sandwiched between the alignment film 13A of array substrate 100 and the alignment film 13B of counter substrate 200) is determined by the dominant wavelength of light that passes through the color filter layer 24 (R, G, B) disposed at the pixel PX. Specifically, the effective thickness (d·Δn) of the liquid crystal layer 300, which is determined in consideration of a refractive index anisotropy Δn of the liquid crystal layer 300, is set so as to maximize the transmittance T of the light that passes through the liquid crystal layer 300 (i.e. the dominant wavelength of light that passes through the color filter layer 24 (R, G, B) disposed at each pixel PX).

In the embodiment shown in FIG. 3, in the case where the array substrate 100 and counter substrate 200 are arranged in parallel, the thickness of the red color filter layer 24R is the minimum and the thickness of the blue color filter layer 24B is the maximum. The following relationship is established:

the thickness of the red color filter layer<the thickness of the green color filter layer<the thickness of the blue color filter layer.

Thereby, two kinds or more of pixels with different gaps are formed in the display region 102.

That is, the multi-gap structure is formed, wherein the gap is the maximum at the red pixel PXR having the red color filter layer 24R and the gap is the minimum at the blue pixel PXB having the blue color filter layer 24B. The following relationship is established:

the gap of the red pixel>the gap of the green pixel>the gap of the blue pixel.

The columnar spacer 31 is not disposed at the pixel with the maximum gap. Preferably, the columnar spacer 31 is disposed at the pixel with the minimum gap. In this embodiment, the columnar spacer 31 is disposed on the blue color filter layer 24B at the blue pixel PXB.

In the above-described multi-gap structure, it is desirable that the columnar spacer 31 be disposed on the color filter layer 24 of any one of the three colors. The reason is as follows. In the multi-gap structure wherein the thickness of the color filter layer 24 (R, G, B) varies from color pixel to color pixel, if columnar spacers of the same shape are disposed, the columnar spacers disposed on the respective color filter layers 24 (R, G, B) have the same height. In this case, the columnar spacers can support the minimum gap but cannot support gaps with greater sizes. Moreover, in order to dispose columnar spacers with different heights in association with the different gaps for the respective pixels, such columnar spacers have to be formed individually. This requires repetition of similar processes of forming columnar spacers. Consequently, the number of fabrication steps greatly increases, and the manufacturing cost rises.

It is thus desirable to dispose the columnar spacer 31 on the color filter layer 24 of any one of the colors. This configuration ensures exact supporting with the gap of the multi-gap structure. There is no considerable increase in number of fabrication steps, and the manufacturing cost can be decreased. Besides, simultaneous formation of the shield layer SP and columnar spacer 31 can achieve a further reduction in number of fabrication steps.

However, in the case where a color resin that is applied to the shield layer SP, in particular, a black photosensitive resin, is used, exposure to a deep part of the photosensitive resin may fail to be carried out in the exposure step of the photolithography process. In other words, in the case where the columnar spacer is formed of a negative-type photosensitive resin material that is rendered insoluble by cross-linking using optical radiation, an optical cross-linking reaction may not progress to a deep part of the resin material. In this case, the deep part may be dissolved in a developing liquid and, as a result, the columnar spacer tends to be formed in an inverse-taper shape (i.e. a distal end portion of the columnar spacer being thicker than a deep-side (proximal-side) part thereof).

The columnar spacer with this shape has a low support strength, and tends to chip easily due to weak shock. Consequently, the uniformity of the gap is lost, and a display defect may occur.

In this embodiment, in the multi-gap structure, the shield layer SP and columnar spacer 31 are formed of the same material in the same step. Thereby, the number of fabrication steps is reduced. In addition, the columnar spacer 31 is disposed at a pixel with a relatively small gap, for instance, the blue pixel PXB (on the blue color filter layer 24B) with the minimum gap. Formation of an inverse-taper columnar spacer is thus suppressed.

The above principle is explained by referring to, for instance, a photolithography process using a black photosensitive resin material. FIG. 5 is a view for explaining a process margin of the black resin material. Part (a) of FIG. 5 illustrates a case where the film thickness of the black resin material is relatively large, and part (b) of FIG. 5 illustrates a case where the film thickness of the black resin material is relatively small.

As shown in part (a) of FIG. 5, in the case where the columnar spacer is to be formed of the relatively thick black resin material, a time that is needed to completely eliminate a residual around the columnar spacer by a development process increases. Needless to say, development at a deep part of the black resin, that is, a bottom part of the columnar spacer, progresses similarly, and the columnar spacer tends to have an inverse-taper shape. As a result, a time interval decreases between the time when the residual is completely eliminated, and the time when a sufficient support strength of the columnar spacer is lost due to formation of the inverse-taper shape. This means that a process margin in the development step is narrow.

On the other hand, as shown in part (b) of FIG. 5, in the case where the columnar spacer is to be formed of the relatively thin black resin material, a time that is needed to completely eliminate a residual around the columnar spacer by a development process decreases. Thus, a time interval increases between the time when the residual is completely eliminated, and the time when a sufficient support strength of the columnar spacer is lost due to formation of the inverse-taper shape. This means that a process margin in the development step is large. That is, since the columnar spacer with the inverse-taper shape is not easily formed, the above-described problem arising from the inverse-taper-shaped columnar spacer can be solved.

It has been found that when the columnar spacer is to be formed of black resin material, the dissolution rate of the black resin material in the development step should preferably be about 0.1 μm/sec from the standpoint of productivity. As regards the columnar spacer formed of black resin material, if the height increases by 0.1 μm, the time that is needed to completely eliminate a residual around the columnar spacer increases by about one second. That is, the process margin decreases by about one second.

It has been confirmed that the process margin that is required in the development step is 10 seconds or more, in consideration of a variance in a general photolithography process. Taking these points into account, various conditions relating to the black resin material, development step, etc. are controlled so as to ensure a sufficient process margin.

The shield layer SP is formed of the same material and in the same step as the columnar spacer 31. Thus, the shield layer SP has substantially the same thickness as the columnar spacer 31. Even where the lower limit value of the height of the columnar spacer 31 is selected, the shield layer SP having substantially the same thickness as the columnar spacer 31 has sufficient shield properties, as a matter of course.

In the multi-gap structure, it is effective to dispose the columnar spacer 31, which is formed of the same material as the shield layer SP, at a pixel with a relatively small gap. In the above-described embodiment, it is desirable to dispose the columnar spacer 31 on the blue color filter layer 24B at the blue pixel PXB that has the minimum gap. In short, when a columnar spacer, which has a height corresponding to the pixel with the maximum gap, is to be formed, the process margin for forming the columnar spacer is small and an inverse-taper-shaped columnar spacer may easily be formed. Consequently, even if the columnar spacer is disposed at the pixel with the maximum gap, a sufficient support strength may not be obtained. To solve this problem, the columnar spacer is disposed not at the pixel with the maximum gap, but at the pixel with a relatively small gap or the minimum gap. Thereby, a desired gap can exactly be created at each pixel, which can maximize the transmittance T of light that passes through the liquid crystal layer 300. In the meantime, in the case where the columnar spacer is disposed at the pixel, the term “pixel” refers to a region surrounded by various lines such as scan lines, signal lines and auxiliary capacitance lines, and this region includes areas over these lines.

The above-mentioned multi-gap structure is described in greater detail. For example, in the structure shown in FIG. 3, attention is paid to the red pixel PXR and blue pixel PXB.

The display region 102 includes at least two kinds of pixels with different gaps, which are arranged in a matrix. The red pixel (first pixel) PXR has a first gap for interposition of the liquid crystal layer 300. The blue pixel (second pixel) PXB has a second gap that is smaller than the first gap. The columnar spacer 31 is not disposed at the red pixel PXR, but at the blue pixel PXB. The columnar spacer 31 creates the second gap.

The first gap and second gap can be controlled by the thicknesses of the color filter layers that are disposed at the associated pixels. Specifically, the array substrate (first substrate) 100 includes the red color filter layer (first color filter layer) 24R in association with the red pixel (first pixel) PXR, and includes the blue color filter layer (second color filter layer) 24B in association with the blue pixel (second pixel) PXB. The red color filter layer 24R has a first film thickness of, e.g. 3.0 μm. On the other hand, the blue color filter layer 24B has a second film thickness of, e.g. 4.0 μm, which is greater than the first film thickness.

The columnar spacer 31 is disposed on the color filter layer 24B of the blue pixel PXB, which is a pixel with a relatively small gap. The columnar spacer 31 contacts the counter substrate 200 and creates a gap for interposition of the liquid crystal layer 300 between the array substrate 100 and counter substrate 200. In this embodiment, the columnar spacer 31 is formed integral with the array substrate 100 with the color filters 24 (R, G, B). The columnar spacer 31 has a height of, e.g. about 5.0 μm. Accordingly, the second gap of, e.g. about 5.0 μm, is formed at the blue pixel PXB. In addition, the first gap of, e.g. about 6.0 μm, is formed at the red pixel PXR. Thereby, a desired multi-gap structure is formed.

Next, a method of fabricating the liquid crystal display panel 10 is described.

In the step of fabricating the array substrate 100, an undercoating layer 60 is formed on the insulative substrate 11. Then, a polysilicon semiconductor layer 112 of, e.g. a pixel TFT 121, and an auxiliary capacitance electrode 61 are formed. After a gate insulation film 62 is formed, various lines such as a scan line Y, an auxiliary capacitance line 52 and a gate electrode 63 that is integral with the scan line Y are formed.

Subsequently, using the gate electrode 63 as a mask, impurities are implanted in the polysilicon semiconductor layer 112, thereby forming a drain region 112D and a source region 112S. The resultant structure is annealed to activate the impurities. Then, after an interlayer insulation film 76 is formed, a signal line X is formed. In addition, a drain electrode 88 of the pixel TFT 121, which is integral with the signal line X, a source electrode 89, and a contact electrode 80 are formed. The drain electrode 88 contacts the drain region 112D via a contact hole 77. The source electrode 89 contacts the source region 112S via a contact hole 78. The contact electrode 80 contacts the auxiliary capacitance electrode 61 via a contact hole 79.

Following the above, color filter layers 24 (R, G, B) of colors corresponding to the respective color pixels are formed. Specifically, using a spinner, an ultraviolet-curing acrylic resin resist film CR-2000 (manufactured by Fujifilm Olin Co., Ltd.), in which a red pigment is dispersed, is coated on the entire surface of the substrate. Then, using a photomask with a pattern corresponding to the red pixel, the resist film is exposed with a wavelength of 365 nm at an exposure amount of 100 mJ/cm². The resist film is developed for 20 seconds in a 1% aqueous solution of KOH. The developed resist film is rinsed and baked. Thus, a red color filter layer 24R that is 3.0 μm thick is formed.

Similar steps are repeated. A green color filter layer 24G that is 3.4 μm thick and is formed of an ultraviolet-curing acrylic resin resist film CG-2000 (manufactured by Fujifilm Olin Co., Ltd.), in which a green pigment is dispersed, is formed. A blue color filter layer 24B that is 4.0 μm thick and is formed of an ultraviolet-curing acrylic resin resist film CB-2000 (manufactured by Fujifilm Olin Co., Ltd.), in which a blue pigment is dispersed, is formed. In the steps of forming the color filter layers 24 (R, G, B), through-holes 26 and contact holes 81 are formed at the same time.

After a pixel electrode 151 is formed, a columnar spacer 31 for creating a desired gap at the blue pixel PXB is formed and, at the same time, a shield layer SP is formed. Specifically, using a spinner, an ultraviolet-curing acrylic resin resist film NN600 (manufactured by JSR), in which 20 wt % of a black pigment is added, is coated on the entire surface of the substrate. The resist film is dried at 90° C. for 10 minutes. Using a photomask with a predetermined pattern, the dried resist film is exposed with a wavelength of 365 nm at an exposure amount of 100 mJ/cm². The resist film is developed in an alkali aqueous solution with pH 11.5, and the developed resist film is baked at 200° C. for 60 minutes.

Thereby, the shield layer SP is formed. In addition, the columnar spacer 31 having a bottom size of 20 μm×20 μm and a height of about 5.0 μm is formed on the blue color filter layer 24B that is the color filter layer with a relatively large thickness. The columnar spacer 31 formed at this time was inspected by means of a scanning electron microscope.

As shown in FIG. 6A, the columnar spacer 31 had a good normal taper shape (i.e. a distal end portion of the columnar spacer being thinner than a deep-side (proximal-side) portion thereof). Moreover, a residual around the spacer was completely eliminated.

In this step, the rate of dissolution for development of the black resist film was set at 0.1 μm/sec in consideration of productivity. It was confirmed that the process margin in this development step was 10 seconds.

Subsequently, a vertical alignment film material SE-7511L (manufactured by NISSAN CHEMICAL INDUSTRIES, LTD.) is coated on the entire surface of the substrate. The coated material is baked, and an alignment film 13A is formed. Thereby, the array substrate 100 is fabricated.

On the other hand, in the process of fabricating the counter electrode 200, a counter electrode 22 is formed on an insulative substrate 21. Then, a vertical alignment film material SE-7511L (manufactured by NISSAN CHEMICAL INDUSTRIES, LTD.) is coated on the entire surface of the substrate. The coated material is baked, and an alignment film 13B is formed. Thereby, the counter substrate 200 is fabricated.

In the process of manufacturing the liquid crystal display panel 10, a seal material 106 is applied, by printing, along the outer peripheral edge of the array substrate 100. In this case, the seal material 106 is applied such that a liquid crystal injection port 32 is formed. Thereafter, an electrode transfer material for applying a voltage from the array substrate 100 to the counter electrode 204 is formed on an electrode-transfer electrode around the seal material 106. The array substrate 100 and counter substrate 200 are positioned such that the alignment film 13A of the array substrate 100 and the alignment film 13B of the counter substrate 200 are opposed to each other. Both substrates are pressed and heated, and the seal material 106 is cured. Thereby, both substrates are bonded. Then, a liquid crystal composition MLC-2039 (manufactured by MERCK) is injected from the liquid crystal injection port 32. The liquid crystal injection port 32 is sealed by a seal member 33. Thus, the liquid crystal layer 300 is formed.

The liquid crystal display panel is manufactured by the above-described method. In addition to the present embodiment, the following display modes, for instance, can be adopted in the liquid crystal display apparatus: TN (twisted nematic) mode, ST (supertwisted nematic) mode, GH (guest-host) mode, ECB (electrically controlled birefringence) mode, and ferroelectric liquid crystal mode.

The color liquid crystal display apparatus manufactured by the above method has the multi-gap structure having such desired gaps that a maximum transmittance is obtained in accordance with the dominant wavelength of light that passes through the liquid crystal layer 300. Moreover, good viewing angle characteristics are attained, and an excellent display quality is obtained.

In order to support the multi-gap structure, the columnar spacer is disposed at the pixel with a relatively small gap. This can reduce the height of the columnar spacer to be formed. Hence, even where the columnar spacer is formed of the same light-shield photosensitive resin material as the shield layer, it can have a relatively small film thickness. Since the cross-linking reaction progresses to a deep part of the photosensitive resin material, the columnar spacer does not easily have an inverse-taper shape. In short, a sufficient process margin can be ensured in the step of developing the photosensitive resin material.

Since the columnar spacer and shield layer are formed of the same material in the same step, the manufacturing cost can be reduced and the manufacturing yield increased. Moreover, it is possible to prevent deficiency in support strength due to an inverse-taper shape of the columnar spacer and chipping of the columnar spacer, and to prevent a display defect due to an improper gap between the substrates. Furthermore, since the color filter layer and columnar spacer are integrally formed on one of the substrates, it is possible to solve the problem with the use of spherical or cylindrical spacers and to improve the display quality.

The present invention is not limited to the above-described embodiment, and various modifications can be made. Other modifications of the present invention will be described below. The structural parts common to those in the above-described embodiment are denoted by like reference numerals, and a detailed description is omitted.

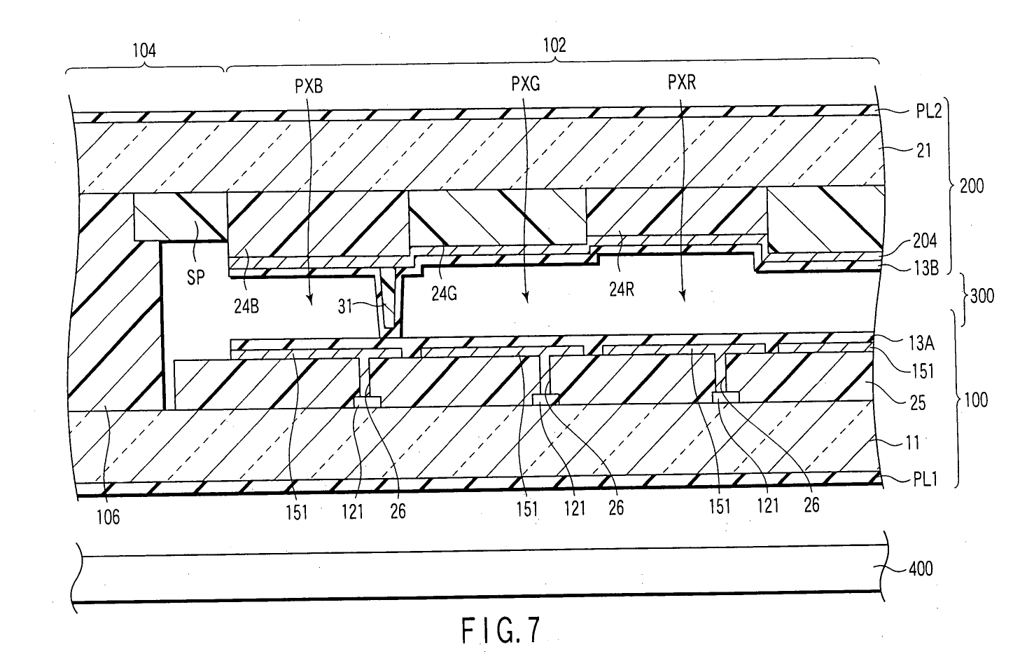

FIG. 7 shows an array substrate 100 of a liquid crystal display panel 10 according to another embodiment of the invention. In the display region 102, the array substrate 100 includes, on the transparent insulative substrate 11, pixel TFTs 121 that are formed in association with a plurality of pixels arranged in a matrix, an insulation layer 25 that is disposed to cover the pixel TFTs 121, pixel electrodes 151 that are disposed on the insulation layer 25 and connected to the pixel TFTs 121 via through-holes 26, and an alignment film 13A that is disposed to cover the entire pixel electrodes 151.

The counter substrate 200 includes color filter layers 24 (R, G, B) that are formed in association with the respective pixels on the transparent insulative substrate 21 in the display region 102. In addition, the counter substrate 200 also includes a counter electrode 204 that is formed on the color filter layers 24 (R, G, B) and is provided commonly for all the pixels, and an alignment film 13B that is disposed to cover the counter electrode 204. In addition, the counter electrode 200 includes a shield layer SP that is disposed on the peripheral region 104 along the outer periphery of the display region 102. The counter substrate 200 includes a columnar spacer 31 that is disposed at a pixel with a relatively small gap and is suited to the multi-gap structure. This columnar spacer 31 is not disposed at the pixel with the maximum gap.

The above-mentioned multi-gap structure is described in greater detail. For example, in the structure shown in FIG. 7, attention is paid to the red pixel PXR and blue pixel PXB.

The red pixel (first pixel) PXR has a first gap for interposition of the liquid crystal layer 300. The blue pixel (second pixel) PXB has a second gap that is smaller than the first gap. The columnar spacer 31 is not disposed at the red pixel PXR, but at the blue pixel PXB. The columnar spacer 31 creates the second gap.

The counter substrate (first substrate) 200 includes the red color filter layer (first color filter layer) 24R in association with the red pixel (first pixel) PXR, and includes the blue color filter layer (second color filter layer) 24B in association with the blue pixel (second pixel) PXB. The red color filter layer 24R has a first film thickness. The blue color filter layer 24B has a second film thickness, which is greater than the first film thickness. The columnar spacer 31 is disposed on the color filter layer 24B of the blue pixel PXB, which is a pixel with a relatively small gap. The columnar spacer 31 contacts the array substrate 100 and creates a gap for interposition of the liquid crystal layer 300 between the array substrate 100 and counter substrate 200. In this embodiment, the columnar spacer 31 is formed integral with the-counter substrate 200 with the color filters 24 (R, G, B). Thereby, a desired multi-gap structure is formed.

Since the columnar spacer 31 and shield layer SP can be formed of the same material in the same step, the number of manufacturing steps can be reduced. Therefore, with the liquid crystal display apparatus having the above structure, the same advantages as with the preceding embodiment can be obtained.

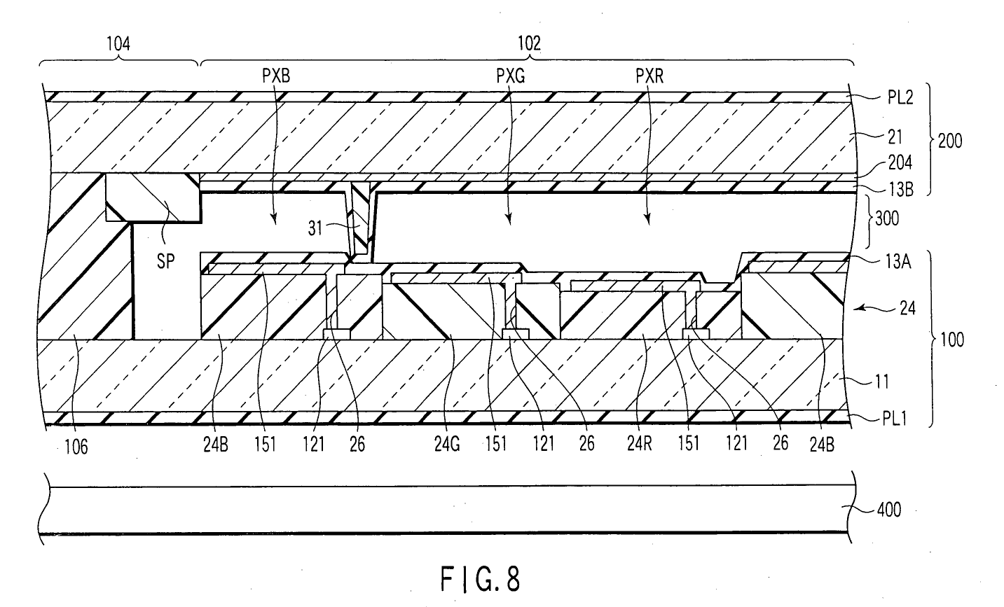

FIG. 8 shows an array substrate 100 of a liquid crystal display panel 10 according to another embodiment of the invention. In the display region 102, the array substrate 100 includes, on the transparent insulative substrate 11, pixel TFTs 121 that are formed in association with a plurality of pixels arranged in a matrix, color filter layers 24 (R, G, B) that are formed in association with the respective pixels, pixel electrodes 151 that are disposed on the color filter layers 24 (R, G, B) and connected to the pixel TFTs 121 via through-holes 26, and an alignment film 13A that is disposed to cover the entire pixel electrodes 151.

The counter substrate 200 includes, on the transparent insulative substrate 21 in the display region 102, a counter electrode 204 that is provided commonly for all the pixels, and an alignment film 13B that is disposed to cover the counter electrode 204. In addition, the counter electrode 200 includes a columnar spacer 31 that is disposed above the color filter layer 24B on the array substrate 100 side and is suited to the-multi-gap structure.

The above-mentioned multi-gap structure is described in greater detail. For example, in the structure shown in FIG. 8, attention is paid to the red pixel PXR and blue pixel PXB.

The red pixel (first pixel) PXR has a first gap for interposition of the liquid crystal layer 300. The blue pixel (second pixel) PXB has a second gap that is smaller than the first gap. The columnar spacer 31 is not disposed at the red pixel PXR, but at the blue pixel PXB. The columnar spacer 31 creates the second gap.

The array substrate (first substrate) 100 includes the red color filter layer (first color filter layer) 24R in association with the red pixel (first pixel) PXR, and includes the blue color filter layer (second color filter layer) 24B in association with the blue pixel (second pixel) PXB. The counter substrate (second substrate) 200 has the columnar spacer 31 in association with the blue pixel.

The red color filter layer 24R has a first film thickness. The blue color filter layer 24B has a second film thickness, which is greater than the first film thickness. The columnar spacer 31 contacts the color filter layer 24B of the blue pixel PXB, which is a pixel with a relatively small gap, and creates a gap for interposition of the liquid crystal layer 300 between the array substrate 100 and counter substrate 200. Thereby, a desired multi-gap structure is formed.

Since the columnar spacer 31 and shield layer SP can be formed of the same material in the same step, the number of manufacturing steps can be reduced. Therefore, with the liquid crystal display apparatus having the above structure, the same advantages as with the preceding embodiments can be obtained.

In the embodiment shown in FIG. 8, the color filter layers 24 (R, G, B) are formed on the array substrate 100, and the columnar spacer 31 and shield layer SP are formed on the counter substrate 200.

Alternatively, the color filter layers 24 (R, G, B) may be formed on the counter substrate 200, and the columnar spacer 31 and shield layer SP may be formed on the array substrate 100.

In each of the above-described embodiments, attention has been paid to the red pixel (first pixel) with the first gap and the blue pixel (second pixel) with the second gap that is smaller than the first gap, and the columnar spacer 31 is disposed at the pixel with the smaller gap (i.e. the blue pixel). The present invention, however, is not limited to these embodiments.

For example, assume that the display region 102 includes a green pixel (first pixel) with a first gap, a blue pixel (second pixel) with a second gap that is smaller than the first gap, and a red pixel (third pixel) with a third gap that is greater than the first gap. The columnar spacer 31 may be disposed at the pixel with the minimum gap (blue pixel PXB), if the following relationship is established:

red pixel gap>green pixel gap>blue pixel gap.

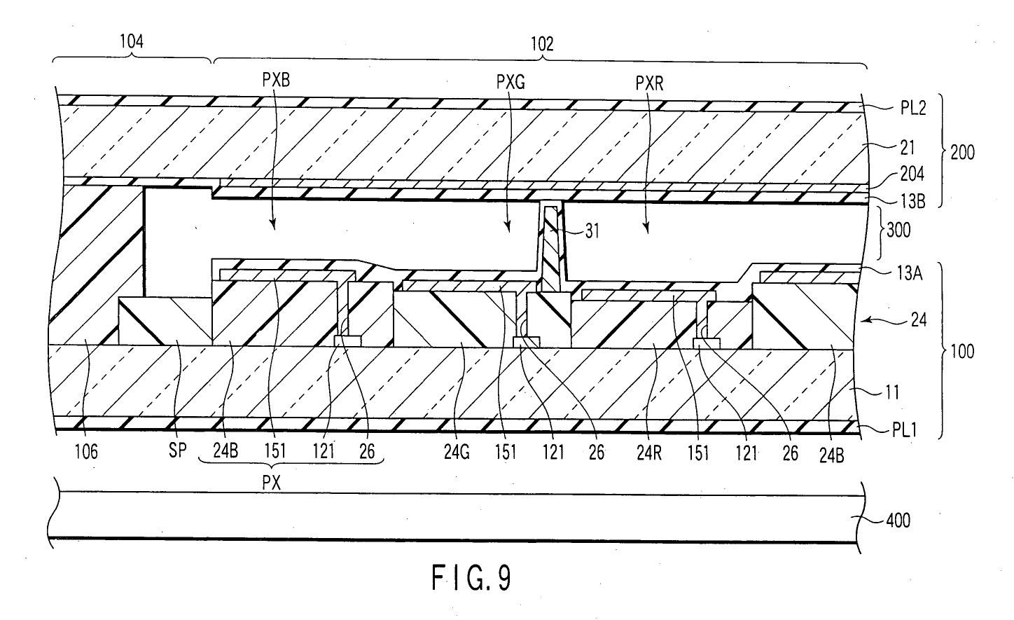

Besides, the columnar spacer 31 may be disposed at a pixel having a relatively small gap. For example, as shown in FIG. 9, assume that the display region 102 includes a red pixel (first pixel) with a first gap, a green pixel (second pixel) with a second gap that is smaller than the first gap, and a blue pixel (third pixel) with a third gap that is smaller than the second gap. In this case, the columnar spacer 31 may be disposed at the green pixel PXG, and not at the red pixel PXR or the blue pixel PXB.

The above-described embodiments are directed to transmission-type liquid crystal panels. The same advantages as with the above-described embodiments, however, can be obtained even where the invention is applied to reflection-type liquid crystal panels.

### COMPARATIVE EXAMPLES

A liquid crystal display apparatus was fabricated. This apparatus is similar to the liquid crystal display apparatus according to the embodiment shown in FIG. 3, except that the black columnar spacer is disposed on the red-pixel color filter layer 24R alone and the height of the black columnar spacer is set at 6.0 μm. Compared to the above-described embodiment, the height of the columnar spacer is greater by 1.0 μm. Consequently, the process margin in the development step for forming the columnar spacer was only 2 seconds. The formed columnar spacer was inspected by means of a scanning electron microscope. A chip due to an inverse-taper shape, as shown in FIG. 6B, or formation of an inverse-taper shape, as shown in FIG. 6C, was confirmed. The fabricated liquid crystal display apparatus was evaluated. A local gap defect occurred and, as a result, a display defect occurred.

As has been described above, according to the liquid crystal display apparatus of the present invention, color filter layers with predetermined thicknesses are formed in association with the respective color pixels. Making use of the difference in thickness of the color filter layers, a multi-gap structure is realized. The multi-gap structure has such a desired gap that the transmittance of light that passes through the liquid crystal layer can take a maximum value. Thereby, good viewing angle characteristics are attained, and an excellent display quality is obtained.

Of a plurality of kinds of pixels with different gaps, the pixel with the maximum gap is not provided with the columnar spacer. The columnar spacer is disposed at the pixel with a relatively small gap. Hence, even where the shield layer and the columnar spacer are formed of the same material, the columnar spacer 31 with a good normal taper shape can be formed and sufficient support strength is ensured. Since the shield layer and columnar spacer are formed of the same material in the same step, the manufacturing cost can be reduced and the manufacturing yield increased.

Therefore, it is possible to provide a liquid crystal display apparatus, which can achieve a high manufacturing yield at low cost, and can realize a high display quality.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A liquid crystal display apparatus configured to have a liquid crystal layer interposed between a first substrate and a second substrate, characterized by comprising:
a plurality of pixels which are disposed in a matrix in a display region that displays an image, the pixels including a first pixel with a first gap for interposition of the liquid crystal layer between the first substrate and the second substrate, and a second pixel with a second gap that is smaller than the first gap; and
a columnar spacer for creating the second gap, the columnar spacer being disposed not at the first pixel but at the second pixel.

2. The liquid crystal display apparatus according to claim 1, characterized in that the columnar spacer is formed of a photosensitive resin material.

3. The liquid crystal display apparatus according to claim 2, characterized in that the columnar spacer has light shield properties.

4. The liquid crystal display apparatus according to claim 2, characterized by further comprising a light shield layer that is disposed in a picture-frame shape along a peripheral edge of the display region, the columnar spacer and the light shield layer being formed of the same material.

5. The liquid crystal display apparatus according to claim 1, characterized in that the first pixel includes a first color filter layer that has a first film thickness and mainly passes first color light,
the second pixel includes a second color filter layer that has a second film thickness, which is greater than the first film thickness, and mainly passes second color light, and
the columnar spacer is disposed over the second color filter layer.

6. The liquid crystal display apparatus according to claim 5, characterized in that the first substrate includes the first color filter layer, the second color filter layer and the columnar spacer, and
the first substrate further includes scan lines disposed in a row direction, signal lines disposed in a column direction, switching elements disposed near intersections of the scan lines and the signal lines, and pixel electrodes that are connected to the switching elements and are disposed in a matrix.

7. The liquid crystal display apparatus according to claim 1, characterized in that said plurality of pixels include a third pixel with a third gap that is smaller than the second gap.

8. The liquid crystal display apparatus according to claim 1, characterized in that said plurality of pixels include a third pixel with a third gap that is greater than the first gap.

9. The liquid crystal display apparatus according to claim 5, characterized in that the first color light has a wavelength that is greater than a wavelength of the second color light.
